(19) United States
(12) Patent Application Publication
(10) Pub. No.: US 2021/0162720 A1
(43) Pub. Date: Jun. 3, 2021

(54) WOODEN DECORATIVE BOARD, MOLDED ARTICLE HAVING WOODEN DECORATIVE BOARD, AND METHOD OF MANUFACTURING MOLDED ARTICLE

(71) Applicant: Panasonic Intellectual Property Management Co., Ltd., Osaka (JP)

(72) Inventors: KAZUHIKO KANEUCHI, Osaka (JP); TOMONORI SUGIYAMA, Osaka (JP); TAKANORI KOSHIMIZU, Osaka (JP); TAKESHI KIRITOSHI, Osaka (JP)

(21) Appl. No.: 17/094,874

(22) Filed: Nov. 11, 2020

(30) Foreign Application Priority Data
Nov. 29, 2019 (JP) 2019-217323

(51) Int. Cl. B32B 21/08; B32B 21/14; B32B 5/02; B32B 7/12; B32B 37/10; B32B 27/36; B32B 21/10; B29C 45/14

(52) U.S. Cl. CPC B32B 21/08; B32B 21/14; B32B 5/022; B32B 7/12; B32B 37/10; B32B 27/365; B29K 2711/14; B29C 45/1418; B32B 2307/412; B32B 2260/026; B32B 2260/046; B32B 2317/16; B32B 2369/00; B32B 21/10

(57) ABSTRACT

A wooden decorative board includes a sliced veneer that is formed of a natural wood or an artificial wood having a plurality of irregularities formed by wooden conduits on a front surface; and a transparent base material disposed on at least one surface of the sliced veneer on a one side, and having a printed layer disposed on a surface opposite to the sliced veneer.

### BACKGROUND

### 1. Technical Field

The present disclosure relates to a wooden decorative board, a method of manufacturing the same, a molded article using the same, and a method of manufacturing the molded article. In particular, the present disclosure relates to a wooden decorative board including a sliced veneer sliced thinly from a natural wood and a transparent base material having a printed layer on a rear surface of the sliced veneer, a molded article having the wooden decorative board using the same, and a method of manufacturing the molded article.

### 2. Description of the Related Art

In recent years, a wide range of design expressions has been demanded as a decorative need in the exterior of home electric appliances and in-vehicle interior fields due to diversification of customer taste. Among these, there is an increasing need for design using a natural wooden sliced veneer and an optical design that displays a symbol mark or a pattern from the rear surface of the sliced veneer when combined with the illumination. In particular, there is a tendency for designs with high design to be demanded, especially for higher-grade products.

There is a method of producing molded parts with a wooden material centering on the sliced veneer, which is a decoration method using the sliced veneer when realizing the above design. In this case, a wooden material adjusted to have a light transmittance different from that of a sliced veneer material on a front surface is disposed on a rear surface of the sliced veneer material on the front surface, and different materials are disposed on the rear surface of the wooden material disposed on the rear surface of the sliced veneer on the front surface and adjusted to have different light transmittance. As a result, there is a method of manufacturing wooden decorative parts that enables optical design in which different materials can be visually recognized from the sliced veneer side on the front surface when the illumination is turned on.

A layer structure of wooden decorative parts in the related art and a method of manufacturing the same in FIG. 8 will be described. FIG. 8 is a cross-sectional view illustrating the layer structure of the wooden decorative parts. In FIG. 8, wooden decorative parts 100 in the related art is provided with sliced veneer 101, translucency adjustment layer 102 disposed on the rear surface thereof, and base layer portion 104 holding tree leaf 103. Sliced veneer 101 is a thin slice of natural wood such as birds eye maple or walnut in which resin is impregnated inside the sliced veneer formed of a natural wood having the original design of the real wood. On the other hand, resin-impregnated translucency adjustment layer 102 disposed on the rear surface of sliced veneer 101 is formed of a relatively inexpensive wood such as agathis. In addition, base layer portion 104 is formed of a remaining thick portion excluding surface layer portions (101 and 102) having a flat surface. Base layer portion 104 is for reinforcing surface layer portions (101 and 102), and has a function of holding tree leaf 103, which is a different material, in a fixed position, and blocking tree leaf 103 from the outside air to prevent deterioration thereof. In addition, a plurality of attachment clips 105 are integrally formed on the rear surface of base layer portion 104 with the same material as that of base layer portion 104. Attachment clip 105 has a known structure in which hooker 106 is integrally formed at a tip end portion of a flexible plate-shaped supporter, and is for easily attaching wooden decorative parts 100 to a predetermined attachment portion of an automobile. In addition, in wooden decorative parts 100, as described above, since the wood flow molding is performed using the wooden material impregnated with the resin material, surface layer portions (101 and 102) and base layer portion 104 are integrally laminated with a desired shape. That is, the cell walls of the fiber cells of each of the wooden materials that form surface layer portions (101 and 102) and base layer portion 104 are each impregnated with a thermosetting resin as a resin compatibility, for example, a melamine resin, to be cured. As a result, surface layer portions (101 and 102) and base layer portion 104 (Japanese Patent No. 6436451) are configured to have translucency. The translucency of surface layer portions (101 and 102) is adjusted to different light transmittances by adjusting the amount of resin impregnated therein, and thus the optimal translucency of each of surface layer portions (101 and 102) is achieved.

Tree leaf 103 formed of a different material is sandwiched between such surface layer portion 102 and base layer portion 104 at a predetermined position. That is, surface layer portion 102 and base layer portion 104 are integrated under the condition that tree leaf 103 is sandwiched between surface layer portion 102 and base layer portion 104.

Next, FIG. 9 illustrates a cross-sectional view of a lighting system combined with the illumination using wooden decorative parts 100. In FIG. 9, the same components as those in FIG. 8 are designated by the same reference numerals and the description thereof will be omitted. FIG. 9 illustrates a lighting system in which housing 108 for fitting and fitting with the completed wooden decorative parts 100, and light source 107 formed of illumination such as an LED installed in housing 108 are assembled. In addition, FIGS. 10A and 10B are plan views of wooden decorative parts 100 when light source 107 is turned off and turned on, and the lighting system in FIG. 9 is viewed from surface A. In FIGS. 10A and 10B, the same components as those in FIGS. 8 to 9 are designated by the same reference numerals and the description thereof will be omitted. As illustrated in FIG. 10A, when light source 107 is turned off, nothing is displayed on the front surface of wooden decorative parts 100 in FIG. 10A. On the other hand, as illustrated in FIG. 10B, when light source 107 is turned on, the light with which tree leaf 103 is illuminated is transmitted through sliced veneer 101 and translucency adjustment layer 102 and displayed on the front surface of wooden decorative parts 100.

### SUMMARY

A wooden decorative board according to the present disclosure includes a sliced veneer that is formed of a natural wood or an artificial wood having a plurality of irregularities formed by wooden conduits on a front surface; and a transparent base material disposed on at least one surface of the sliced veneer on a one side, and having a printed layer disposed on a surface opposite to the sliced veneer.

As described above, by using the wooden decorative board, the molded article having the wooden decorative board, and the method of manufacturing the molded article according to the present disclosure, it is possible to cope with a wide range of variations such as complicated geometric patterns, precise symbol mark display, and graphic expression such as graphics in the design by the optical design when combining the wooden decorative parts and the illumination. Moreover, it is possible to achieve both high definition and high quality optical display when the illumination is turned on while ensuring a concealing property of the design of the optical design from the front surface to the rear surface of the sliced veneer when the illumination is turned off, and to control even the color appearance of the illumination. These are difficult to realize with the wooden decorative parts in the related art. In addition, by reducing the cost by decreasing the wooden material used than in the related art, and by realizing highly accurate alignment of the design of the optical design in the molded article by the printed layer, the range of application to various products can be expanded. As a result, it is possible to provide the molded article having the wooden decorative board capable of coping with the optical design at a lower cost than in the related art.

### BRIEF DESCRIPTION OF THE DRAWINGS

FIG. 1 is a cross-sectional view illustrating a layer structure of a wooden decorative board according to Exemplary Embodiment 1;

FIG. 2A is a cross-sectional view illustrating one step in a method of manufacturing the wooden decorative board according to Exemplary Embodiment 1;

FIG. 2B is a cross-sectional view illustrating one step in the method of manufacturing the wooden decorative board according to Exemplary Embodiment 1;

FIG. 2C is a cross-sectional view illustrating one step in the method of manufacturing the wooden decorative board according to Exemplary Embodiment 1;

FIG. 3A is a cross-sectional view illustrating one step in a method of manufacturing an insert-molded article using the wooden decorative board according to Exemplary Embodiment 1;

FIG. 3B is a cross-sectional view illustrating a step in the method of manufacturing the insert-molded article using the wooden decorative board according to Exemplary Embodiment 1;

FIG. 3C is a cross-sectional view illustrating a step in the method of manufacturing the insert-molded article using the wooden decorative board according to Exemplary Embodiment 1;

FIG. 3D is a cross-sectional view illustrating a step in the method of manufacturing the insert-molded article using the wooden decorative board according to Exemplary Embodiment 1;

FIG. 3E is a cross-sectional view illustrating a step in the method of manufacturing the insert-molded article using the wooden decorative board according to Exemplary Embodiment 1;

FIG. 3F is a cross-sectional view illustrating a step in the method of manufacturing the insert-molded article using the wooden decorative board according to Exemplary Embodiment 1;

FIG. 3G is a cross-sectional view illustrating a step in the method of manufacturing the insert-molded article using the wooden decorative board according to Exemplary Embodiment 1;

FIG. 3H is a cross-sectional view illustrating a step in the method of manufacturing the insert-molded article using the wooden decorative board according to Exemplary Embodiment 1;

FIG. 3I is a cross-sectional view illustrating a step in the method of manufacturing the insert-molded article using the wooden decorative board according to Exemplary Embodiment 1;

FIG. 4 is a cross-sectional view illustrating a layer structure of a wooden decorative board for comparison and verification according to Exemplary Embodiment 1;

FIG. 5A is a cross-sectional view illustrating a layer structure of an insert-molded article having a wooden decorative board insert-molded using the wooden decorative board according to Exemplary Embodiment 1;

FIG. 5B is a partially enlarged view of the insert-molded article in FIG. 5A;

FIG. 5C is a plan view of a printed layer formed on a transparent base material from surface B of the insert-molded article in FIG. 5A, which is magnified and observed with a microscope;

FIG. 5D is a cross-sectional view illustrating a layer structure of an insert-molded article having a wooden decorative board insert-molded by using an experimental wooden decorative board;

FIG. 5E is a partially enlarged view of the insert-molded article in FIG. 5D;

FIG. 5F is a plan view of a printed layer formed on a transparent base material from surface B of the insert-molded article in FIG. 5D, which is magnified and observed with the microscope;

FIG. 6A is a cross-sectional view illustrating a layer structure of a wooden decorative board according to Exemplary Embodiment 2;

FIG. 6B is a cross-sectional view illustrating a layer structure in which a cutout portion is provided in a nonwoven fabric layer of the wooden decorative board in FIG. 6A;

FIG. 7A is a cross-sectional view illustrating a layer structure of a wooden decorative board according to Modification Example 1 of Exemplary Embodiment 2;

FIG. 7B is a cross-sectional view illustrating a layer structure in which a nonwoven fabric layer is further provided on the wooden decorative board in FIG. 7A;

FIG. 7C is a cross-sectional view illustrating a layer structure in which a cutout portion is provided in the nonwoven fabric layer of the wooden decorative board in FIG. 7B;

FIG. 8 is a cross-sectional view illustrating a layer structure of wooden decorative parts in the related art;

FIG. 9 is a cross-sectional view of a lighting system using the wooden decorative parts in the related art;

FIG. 10A is a plan view of the lighting system using the wooden decorative parts in the related art when the lighting system is turned off;

FIG. 10B is a plan view of the lighting system using the wooden decorative parts in the related art when the lighting system is turned on;

FIG. 11A is a schematic cross-sectional view illustrating one step in a method of manufacturing the wooden decorative parts in the related art;

FIG. 11B is a schematic cross-sectional view illustrating one step in the method of manufacturing the wooden decorative parts in the related art;

FIG. 11C is a schematic cross-sectional view illustrating a step in the method of manufacturing the wooden decorative parts in the related art; and

FIG. 11D is a schematic cross-sectional view illustrating one step in the method of manufacturing the wooden decorative parts in the related art.

### DETAILED DESCRIPTIONS

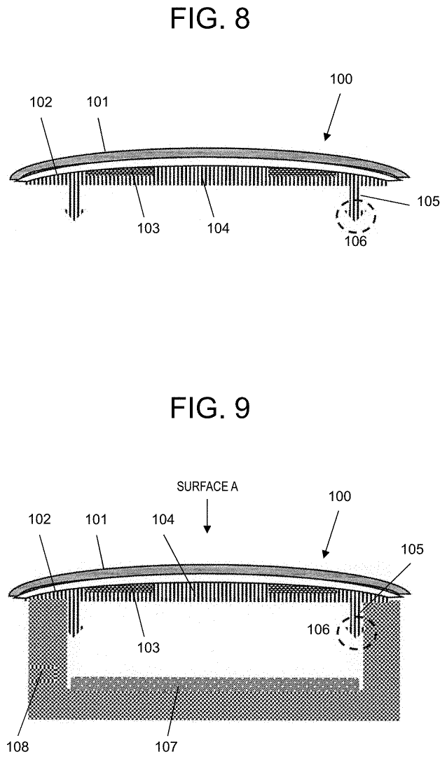

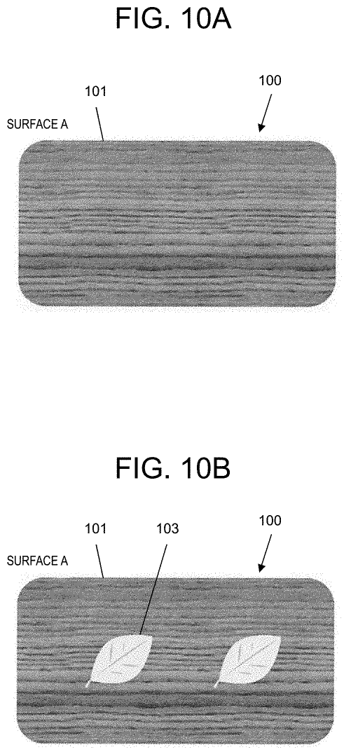

In the prior art disclosed in the above-described patent document, the wooden decorative parts in the related art described in FIGS. 8 to 10B has the following problems.

First, in wooden decorative parts 100 in the related art in FIG. 8, wooden materials are used for the entire wooden decorative parts 100. When aiming to reduce the cost of wooden decorative parts 100, since the wooden material originally having a high material cost is used, there is a problem that the unit cost of wooden decorative parts 100 is increased and the products that can be adopted are limited. In addition, since the different material used for the optical design uses tree leaf 103, which is a wooden material, it is difficult to support a wide range of designs, and for example, there is a problem that it is difficult to express a design of a complicated geometric pattern or display a graphic pattern.

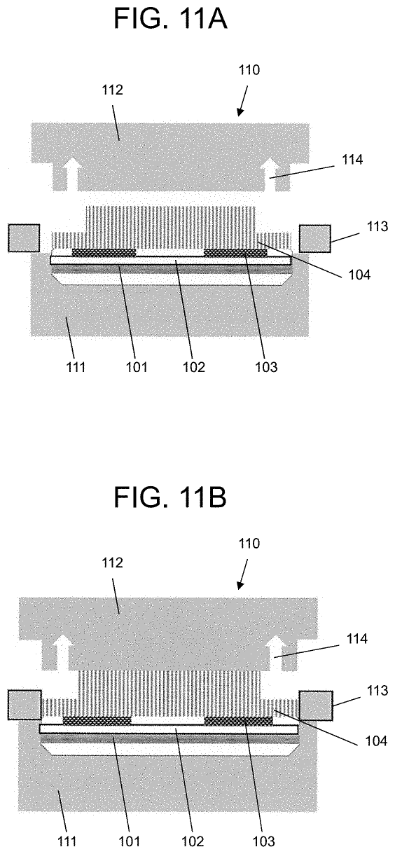

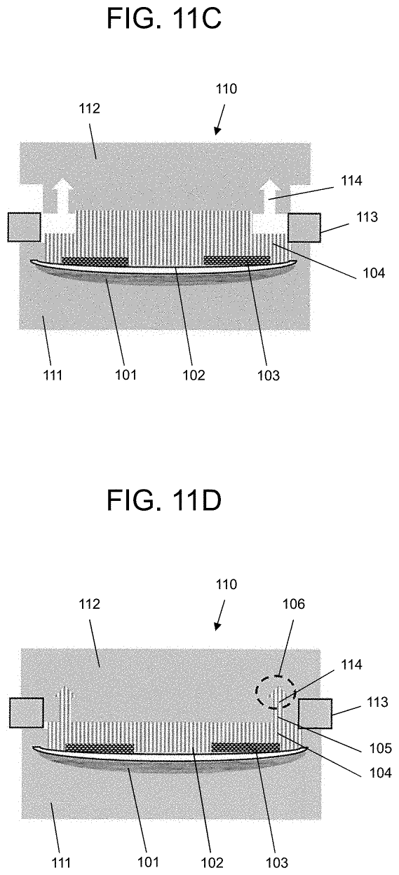

In addition, a method of manufacturing wooden decorative parts 100 in the related art will be described with reference to FIGS. 11A to 11D. In FIGS. 11A to 11D, the same components as those in FIGS. 8 to 10B are designated by the same reference numerals and the description thereof will be omitted.

In FIGS. 11A to 11D, a manufacturing step diagram of the wood flow molding of the wooden decorative parts in the related art will be described.

(1) As illustrated in FIG. 11A, first, the materials of sliced veneer 101, translucency adjustment layer 102, tree leaf 103, and base layer portion 104, which are necessary for manufacturing wooden decorative parts 100 in the related art, are disposed between recessed mold 111 and projected mold 112 of press mold 110.

(2) Next, as illustrated in FIG. 11B, the materials are sandwiched between recessed mold 111 and projected mold 112 of press mold 110, and deformation inhibiter 113 is operated to start pressing.

(3) Next, as illustrated in FIG. 11C, the material of base layer portion 104 is deformed with projected mold 112, and inside recessed mold 111, sliced veneer 101, translucency adjustment layer 102, tree leaf 103, and base layer portion 104 are deformed according to the shape of press mold 110.

(4) Next, as illustrated in FIG. 11D, press mold 110 is pushed to the end to be deformed into a predetermined shape of wooden decorative parts 100. At this time, finally, press mold 110 is deformed so that base layer portion 104 is inserted into clip former 114 of press mold 110, and the wood flow molding is completed.

At this time, in order to completely cure thermosetting resin such as a melamine resin or a phenol resin, which is impregnated in advance in each member of wooden decorative parts 100, this is a process in which the impregnated thermosetting resin is completely cured by heating a heater not illustrated in press mold 110. At this time, in the wood flow molding, the impregnated thermosetting resin is cured by heating the temperature of the press mold from 100° C. to 200° C., depending on the type of thermosetting resin impregnated.

As described above, wooden decorative parts 100 in the related art is completed through the processes (1) to (4). As described above, the arrangement of tree leaf 103, which is the key to determining the design of the optical design in wooden decorative parts 100 in the related art, needs to be set and aligned before the press molding each time in the above step (1).

Therefore, in the wood flow molding in the press molding step, tree leaf 103 is easily displaced in accordance with the fluidity of each wooden material in pressing, and when applied to a member that requires precise alignment, there is also a problem that the molding yield is deteriorated due to the displacement of tree leaf 103.

The present disclosure solves the above-described problems in the related art, and an object thereof is to provide a wooden decorative board that has a high degree of freedom in selecting a design of an optical design disposed on the rear surface of a sliced veneer and that enables high-quality display during the optical design.

In addition, when the illumination is turned off, the design disposed on the rear surface of the sliced veneer from the front surface of the sliced veneer can have a sufficient concealing property in which the design is not visually recognized, and the use of a wooden material having a high material cost can be reduced. In addition, it is possible to provide a wooden decorative sheet that can be accurately aligned during insert molding the alignment in the designed wooden decorative parts disposed on the rear surface of sliced veneer 101 necessary for optical design, a method of manufacturing the same, and a molded article using the same.

A wooden decorative board according to a first aspect includes a sliced veneer that is formed of a natural wood or an artificial wood having a plurality of irregularities formed by wooden conduits on a front surface; and a transparent base material disposed on at least one surface of the sliced veneer on a one side, and having a printed layer disposed on a surface opposite to the sliced veneer.

With the above configuration, it is possible to reduce the use of wooden material, which has a higher material cost than the wooden decorative parts in the related art, and the design displayed by the optical design has a wide range of selections from complicated geometric patterns to graphic expression such as graphics, by the printed layer formed on the transparent base material.

In addition, the symbol mark for the optical design and the design layer can be simultaneously aligned by the printed layer, and a mark for the alignment of the sliced veneer and the printed layer can also be formed by printing with highly accurate alignment. Furthermore, when producing the final molded article having a wooden decorative board during insert molding, the symbol mark, the design layer, and the like can be accurately aligned in the molded article by using the alignment mark as a reference.

In addition, by optimizing the ink material used for the printed layer, color appearance adjustment, and laminating method, the concealing property for ensuring the invisibility of the printed layer from the front surface of the sliced veneer when the illumination on the rear surface of the sliced veneer is turned off, and the chromaticity adjustment for preventing the color appearance of the light transmitted through the sliced veneer from changing when the illumination on the rear surface of the sliced veneer is turned on can all be controlled by the printed layer. As a result, a high quality display can be achieved when the illumination of the printed layer formed on the transparent base material is turned on.

With the configuration of the above wooden decorative board, it is possible to prevent cracks from occurring in the printed layer by press-fitting the printed layer into the irregularities of the multiple conduits on the front surface of the sliced veneer and inserting the printed layer into the conduits due to the influence of the injection pressure applied when filling the injection resin during molding.

In a wooden decorative board according to a second aspect, in the first aspect, the transparent base material may be formed of a non-stretched transparent base material, or a cast or extrusion-molded transparent base material.

With the above configuration, when heat and pressure due to the injection molding resin are applied to the wooden decorative board having a multilayer structure during insert molding, there is no residual stress inside the transparent base material. Therefore, the amount of deformation of the single transparent base material due to the influence of the residual stress inside the transparent base material decreases, and the transparent base material follows and deforms in accordance with the sliced veneer. Therefore, it is possible to prevent delamination due to the difference in deformation behavior between the sliced veneer and the transparent base material, and to obtain a good molded article having the wooden decorative board.

In a wooden decorative board according to a third aspect, in the first or second aspect, the printed layer may be formed of a layer having a light-transmitting property and a layer having no light-transmitting property.

In a wooden decorative board according to a fourth aspect, in any one of the first to third aspects, the transparent base material may have at least two layers or more, and the printed layer may be disposed between the two layers of the transparent base material.

In a wooden decorative board according to a fifth aspect, in any one of the first to fourth aspects, in the transparent base material disposed on the one surface of the wooden decorative board on the one side, a nonwoven fabric layer may be disposed on an outermost layer of the surface opposite to the sliced veneer.

In a wooden decorative board according to a sixth aspect, in any one of the first to fifth aspects, in the transparent base material disposed on the one surface of the wooden decorative board on the one side, a nonwoven fabric layer may be disposed on an outermost layer of the surface opposite to the sliced veneer, a portion of the nonwoven fabric layer may have a pattern of a specific shape not covering the transparent base material, and an adhesive layer may be provided on a surface of the transparent base material not covered with the nonwoven fabric layer.

In a wooden decorative board according to a seventh aspect, in any one of the first to sixth aspects, a protective layer may be provided on a surface of the wooden decorative board opposite to a surface on which the transparent base material is disposed.

In a wooden decorative board according to an eighth aspect, in any one of the first to seventh aspects, the sliced veneer may be impregnated with a resin in an inside of the sliced veneer.

A method of manufacturing a wooden decorative board according to a ninth aspect includes a step of preparing a sliced veneer impregnated with a resin and a transparent base material on which a printed layer is formed; and a step of laminating the sliced veneer and the transparent base material, adhering the sliced veneer and the transparent base material by any one of methods of hot pressing, vacuum heat laminating, vacuum forming, pressure forming, and vacuum pressure forming, and integrating the sliced veneer and the transparent base material to obtain a wooden decorative board.

A method of manufacturing a molded article according to a tenth aspect includes a step of preforming the wooden decorative board by hot pressing processing into a shape close to a final product using the wooden decorative board of any one of the first to eighth aspects; and an insert molding step of injection molding a molding resin layer on a surface on the transparent base material side of the preformed wooden decorative board.

A molded article according to the eleventh aspect includes the wooden decorative board of any one of the first to eighth aspects on a front surface of the molded article.

Hereinafter, a wooden decorative board according to exemplary embodiments and a method of manufacturing the same will be described with reference to the accompanying drawings. In the drawings, substantially the same members are designated by the same reference numerals.

### Exemplary Embodiment 1

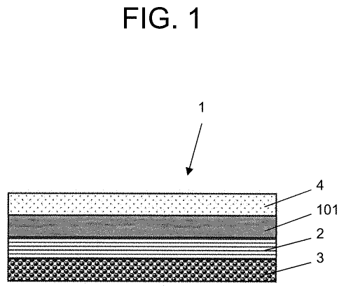

FIG. 1 is a cross-sectional view illustrating the layer structure of the wooden decorative board according to Exemplary Embodiment 1. In FIG. 1, the same components as those in FIGS. 8 to 11D are designated by the same reference numerals and the description thereof will be omitted.

Wooden decorative board 1 according to Exemplary Embodiment 1 in FIG. 1 is provided with sliced veneer 101 and transparent base material 2 disposed on one surface of sliced veneer 101 on a one side. Sliced veneer 101 is formed of a natural wood or an artificial wood having a plurality of irregularities are formed by wooden conduits on a front surface. In transparent base material 2, printed layer 3 is disposed on the surface opposite to sliced veneer 101. Furthermore, protective layer 4 for protecting sliced veneer 101 may be disposed on the surface of sliced veneer 101 opposite to the surface on which transparent base material 2 is disposed.

With the above configuration, it is possible to cope with a wide range of variations such as complicated geometric patterns, precise symbol mark display, and graphic expression such as graphics in the design by the optical design when combining the wooden decorative parts and the illumination. Moreover, it is possible to achieve both high definition and high quality optical display when the illumination is turned on while ensuring a concealing property of the design of the optical design from the front surface to the rear surface of the sliced veneer when the illumination is turned off, and to control even the color appearance of the illumination.

Hereinafter, the components forming wooden decorative board 1 will be described.

### Sliced Veneer

Sliced veneer 101 used in Exemplary Embodiment 1 is formed of the natural wood or the artificial wood having a plurality of irregularities are formed by the wooden conduits on the front surface. The average thickness of sliced veneer 101 is 0.1 mm or more and 0.5 mm or less, and for example, 0.2 mm or more and 0.4 mm or less. When the thickness is less than 0.1 mm, sliced veneer 101 is thin and easily cracks during handling. In addition, when the thickness is more than 0.5 mm, the followability in molding as a sheet is poor and the light-transmitting property is poor, the transparency of printed layer 3 formed on transparent base material 2 disposed on the rear surface of sliced veneer 101 is poor, and it is difficult to display a desired optical design. However, for the thickness of sliced veneer 101, there is no problem even when the thickness is out of the above range as long as the desired effect is obtained. In addition, for the type of sliced veneer 101, it is possible to use a natural wood having a wood grain such as a straight grain, a flat grain, or a highly rare wood grain. In recent years, a sliced veneer manufactured with an artificial wood, which has no appearance different from a sliced veneer of a natural wood and is manufactured by utilizing waste wood, may be used. In addition, as for the tree species, any tree species having light-transmitting property may be used, and for example, birds eye maple, cherry, satin sycamore and the like can be used. In addition, it is not particularly limited as long as other than the above has light-transmitting property. In addition, in the present exemplary embodiment, as sliced veneer 101, sliced veneer 101 impregnated with resin in advance is used.

Polyethylene glycol (hereinafter referred to as PEG) is normally used as the resin to be impregnated. From the viewpoint of preventing the impregnated resin from seeping out onto the front surface of sliced veneer 101 after resin impregnation, for example, the resin having a molecular weight of 1,000 or more and 2,000 or less is used. Examples of the resin for impregnating sliced veneer 101 include water-based polyethylene glycol (PEG), acryl, polyvinyl alcohol, or the like, and an appropriate resin may be selected according to the application. For example, there is no problem when the inside of sliced veneer 101 can be impregnated with a thermoplastic resin, a thermosetting resin, a two-liquids curable resin, an ultraviolet/EB curable pre-cure resin, or an ultraviolet/EB curable after-cure resin, and the molecular weight and the like may be appropriately selected according to the physical properties of each resin to be impregnated. In addition, impregnation of sliced veneer 101 with resin is not essential, and it may be determined whether sliced veneer 101 is impregnated with resin as necessary. It is not particularly limited thereto as long as the same effect can be obtained with the resin materials other than the above. The purpose of impregnating sliced veneer 101 with PEG is to improve the flexibility of sliced veneer 101 and the light-transmitting property of sliced veneer 101. When the molecular weight is less than 1,000, the fluidity of PEG is high after sliced veneer 101 is impregnated with the resin, so that the impregnated PEG easily seeps to the front surface of sliced veneer 101 again, which may cause slippage on the front surface of sliced veneer 101 by touch. In addition, when the molecular weight exceeds 2,000, the efficiency of impregnation into sliced veneer 101 is poor, and it is difficult to stably impregnate the inside of sliced veneer 101 with PEG, and the amount of PEG impregnation easily varies. As a result, in a case where sliced veneer 101 is insufficiently impregnated with PEG, it may cause fragility of sliced veneer 101 during handling. The concentration of the PEG aqueous solution at the time of impregnation is, for example, from 20 to 50 wt %, and it is not particularly limited to this range as long as the desired effect is obtained.

### Adhesive Layer

An adhesive layer (not illustrated) is formed between transparent base material 2 and sliced veneer 101, and the type of the adhesive layer can be bonded using a thermoplastic hot melt sheet, a two-liquids curing type adhesive material, a thermosetting type adhesive material, or the like. In particular, in a case of considering the flexibility required for the preform processing of wooden decorative board 1 and the heat resistance that can withstand the heat of the injection resin during insert molding, for example, a two-liquids curing type adhesive material is used as the adhesive layer. This two-liquids curing type adhesive material has both flexibility and heat resistance. The adhesive layer is not particularly limited and there is no problem as long as the adhesive layer is appropriately used depending on the application. In Exemplary Embodiment 1, bonding is performed using a copolymer of vinyl chloride resin and vinyl acetate resin, which is a composite resin material capable of urethane crosslinking with an isocyanate curing agent. The thickness is a dry film thickness, and is formed, for example, from 3 to 100 μm. When the thickness is less than 3 μm, it is difficult to exert sufficient adhesive force to bond sliced veneer 101 and transparent base material 2, and even when the thickness exceeds 100 μm and the thickness is further increased, the adhesive force does not change and only the cost of forming the adhesive layer is increased.

### Transparent Base Material

In addition, transparent base material 2 has a thickness of, for example, 30 μm or more and 200 μm or less, and further approximately 50 μm or more and 100 μm or around. When the thickness is less than 30 μm, the handling of transparent base material 2 is poor when printed layer 3 is formed. In addition, when the thickness is thicker than 200 μm, the light passing through printed layer 3 diffuses in transparent base material 2 when it is desired to irradiate the light from the surface of printed layer 3. In this case, in a case where printed layer 3 has a multi-layered concealing layer, for example, the concealing layer of the printed layer forms a symbol mark such as a blank character, the light passed through the concealing layer is diffused in transparent base material 2 than the actual line width of the symbol mark of the concealing layer, and the line width of the symbol mark is enlarged and displayed. Therefore, as the thickness of transparent base material 2 is thicker, the diffusion distance of light is wider, so that the line width of the symbol mark displayed on the front surface of sliced veneer 101 is thicker, which causes a display blur. In addition, as transparent base material 2 used in Exemplary Embodiment 1 may be, for example, an unstretched PET film, an acrylic film formed by casting or extrusion molding, or a polycarbonate film may be used. In a case where a biaxially stretched PET film is used for transparent base material 2, and an insert molding step or the like is performed after bonding sliced veneer 101 and the biaxially stretched PET film as transparent base material 2, there are the following problems. That is, when a force that deforms sliced veneer 101 or transparent base material 2 by heat and pressure of the injection resin during insert molding is applied, the residual stress remaining in transparent base material 2 during the biaxial stretching processing is released. In this case, the relaxation force of the residual stress in the biaxially stretched PET film of transparent base material 2 is stronger than the bonding force at the interface between sliced veneer 101 and transparent base material 2. As a result, the behavior of sliced veneer 101 and the behavior of transparent base material 2 are different during insert molding, and transparent base material 2 cannot follow the movement of the sliced veneer board 101, which causes delamination between sliced veneer 101 and transparent base material 2. In Exemplary Embodiment 1, an acrylic film having an average thickness of approximately 50 μm without residual stress was used in transparent base material 2 manufactured by extrusion molding containing a rubber component added for the purpose of increasing the flexibility of transparent base material 2.

### Printed Layer

Next, printed layer 3 of Exemplary Embodiment 1 will be described. Printed layer 3 is formed in multiple layers. Printed layer 3 is formed in order of at least a light-transmitting layer and a light-impermeable layer from transparent base material 2 side (not illustrated). A color appearance adjustment layer for showing the color appearance of the original sliced veneer 101 not to be impaired when sliced veneer 101 is visually viewed, a light diffusion layer for uniformly diffusing the light of the illumination when the illumination is illuminated from the rear surface of sliced veneer 101, a chromaticity adjustment layer of light for correcting the color appearance to extract in the predetermined color appearance of the illumination light because the color appearance of the light source color of the illumination changes due to passing through sliced veneer 101, and an adhesive layer for adhering to injection molding resin and other materials correspond to the light-transmitting layer. In addition, the light-impermeable layer corresponds to a concealing layer for forming a black ink layer or the like to absorb the light of illumination emitted from the rear surface of sliced veneer 101 and cutting off light other than the pattern where characters and symbols are omitted, so that light other than characters and symbols is not transmitted, in a case where a pattern such as a symbol mark is displayed. In Exemplary Embodiment 1, printed layer 3 is formed on transparent base material 2 by screen printing. In addition, printed layer 3 is formed by using a two-liquids curing type ink as a screen ink material. In the exemplary embodiment, the color appearance adjustment layer that does not impair the color appearance of sliced veneer 101 from transparent base material 2 side, the light diffusion layer for diffusing the illumination light, the chromaticity adjustment layer for correcting the color appearance to extract in the color appearance of the predetermined light because the color appearance of the light of illumination changes due to the effect of the color appearance of sliced veneer 101, the concealing layer for forming the display symbol mark of the operation part such as the interior of the vehicle, and the adhesive layer which can be adhered to the injection molding resin layer are formed. Each layer is formed by screen printing so as to have an average dry film thickness of 2 to 5 μm per layer, and an appropriate number of layers is formed between each of the layers 1 and 2.

### Protective Layer

Next, for the purpose of protecting the front surface of sliced veneer 101 on the front surface side of sliced veneer 101, protective layer 4 may be formed on the surface of sliced veneer 101 opposite to the surface on which transparent base material 2 is formed. Protective layer 4 used in wooden decorative board 1 is not particularly limited, and it is not particularly limited as long as the intended effect such as a transfer method using a transfer film or coating by painting can be obtained. In wooden decorative board 1, a multilayer protective layer is formed using a transfer foil on the front surface of sliced veneer 101 by the transfer foil (not illustrated).

The details of protective layer 4 are a hard coat layer, an anchor layer, a UV cut layer, and an adhesive layer for sliced veneer, which are transferred to the front surface of the sliced veneer to collectively constitute protective layer 4. In addition, the transfer film which is the base of the protective layer may be produced by a continuous roll film already in the literature or the like, or by a sheet film, and is normally produced by a roll film having high productivity. For transfer, it is desirable to use the average thickness of the base film used for the film in the range of 20 μm or more and 50 μm or less. In addition, in order to further improve the followability of the transfer film when transferring onto the front surface of the sliced veneer, the average thickness is 30 μm or more and 50 μm or less, for example. In a case where the base film is thinner than 20 μm, when forming the release layer, the hard coat layer, the anchor layer, the UV cut layer, and the adhesive layer for sliced veneer on the base film in the production of the transfer film, when the base film is too thin by applying heat drying or UV curing in the process of forming each layer, wrinkles, tears, and warpage are likely to occur, resulting in poor handling. In addition, in a case where the thickness of the base film is thicker than 50 μm, the followability of the transfer film to the transferred material is likely to deteriorate. Moreover, in a case where it is desired to hold the base film without peeling it from the transfer target immediately after the transfer film is transferred, the contraction amount of the base film is larger than that of sliced veneer 101 when comparing the contraction amount of sliced veneer 101 and that of the base film. Therefore, sliced veneer 101 is pulled by the contraction of the base film and the warpage increases, and it is difficult to handle as the wooden decorative board. In addition, in a case where the thickness is thicker than 50 μm as compared with the case where a thin film is used as the base film, the thickness of the roll film having the same number of turns as the transfer film is thick and the weight is heavy, so that the film is difficult to carry and is difficult to handle. Furthermore, the cost of the base film increases. The thickness of the base film may be appropriately selected within the above range depending on the purpose, and there is no problem even when the thickness exceeds the above range as long as the same effect can be obtained. A PET film that is easily available is normally used as the base film, and there is no particular limitation as long as the same effect can be obtained with other materials. In addition, normally, in a case where a protective layer is formed on sliced veneer 101 using a transfer foil, there is no problem as long as the total thickness of the hard coat layer, the anchor layer, the UV cut layer, and the adhesive layer for sliced veneer, which are the protective layer formed on sliced veneer 101, is formed from 30 μm to 50 μm, assuming a normal transfer film. The range is not particularly limited as long as a predetermined effect can be obtained.

### Method of Manufacturing Wooden Decorative Board

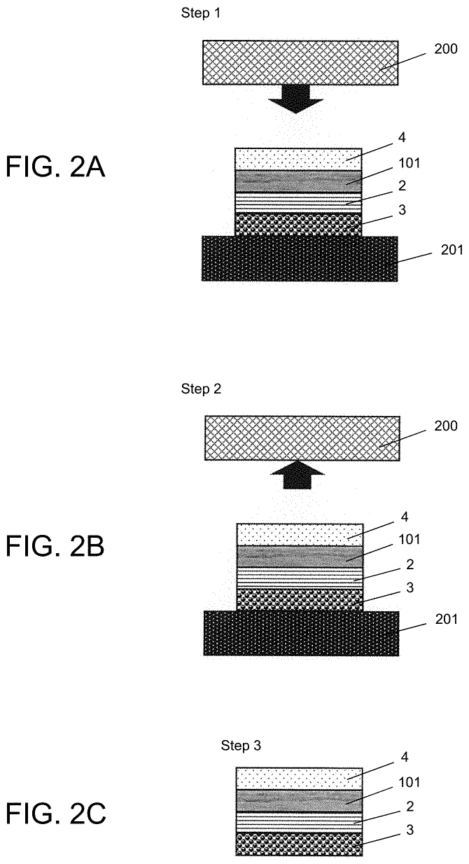

A manufacturing process of the wooden decorative board according to Exemplary Embodiment 1 will be described with reference to FIGS. 2A, 2B, and 2C. In FIGS. 2A, 2B, and 2C, the same components as those in FIG. 1 and FIGS. 8 to 11D are designated by the same reference numerals and the description thereof will be omitted. FIGS. 2A, 2B, and 2C are a process of manufacturing the wooden decorative board by adhering protective layer 4, sliced veneer 101, and transparent base material 2 on which printed layer 3 is formed in advance with a transfer film (not illustrated) using hot press processing.

(1) As illustrated in FIG. 2A, first, in Step 1, first press mold 200 and second press mold 201 for press processing are heated to a predetermined temperature in advance, and protective layer 4, sliced veneer 101, and transparent base material 2 on which printed layer 3 is formed on the sheet of transfer film (not illustrated) are sandwiched. As a result, the adhesive layer for sliced veneer of protective layer 4 on the transfer film (not illustrated) and sliced veneer 101 are heated and pressure-adhered. In addition, the adhesive layer for sliced veneer formed on transparent base material 2 (not illustrated) and sliced veneer 101 are heated and pressure-adhered. In a case where sliced veneer 101 is a continuous sheet, the transfer film (not illustrated) or transparent base material 2 on which printed layer 3 is formed may be supplied not by the sheet but by a roll and transparent base material 2 on which protective layer 4 and printed layer 3 are formed may be adhered to sliced veneer 101. In Exemplary Embodiment 1, a nonwoven fabric is used for the support this time.

The mold used for hot press processing may be a metal mold, a wood mold, or a resin mold, and it is not limited to a mold formed of any other material as long as the same effect can be obtained. When sandwiching between first press mold 200 and second press mold 201 in Step 1, and pressing sliced veneer 101 from the transfer film side on which protective layer 4 (not illustrated) is formed by first press mold 200, the air layer between the transfer film (not illustrated) and sliced veneer 101 is escaped to the outside along the front surface of sliced veneer 101 by the pressure of first press mold 200. In addition, the air layer between sliced veneer 101 and transparent base material 2 is also escaped to the outside along the front surface of sliced veneer 101 by the pressure of first press mold 200. At that time, the air inside the conduit (not illustrated) existing on the front surface of sliced veneer 101 is also escaped. The inside of the conduit (not illustrated) of sliced veneer 101 is a portion where wood fibers are sparse and has a porous shape. In addition, in order to facilitate the escape of air, the front surface of the mold used for hot press processing may be embossed to provide irregularities having a size for facilitating the escape of air. When the adhesive layer for sliced veneer of the transfer film on which protective layer 4 (not illustrated) is formed and sliced veneer 101, and sliced veneer 101 and the adhesive layer for sliced veneer (not illustrated) formed on transparent base material 2 are heat-adhered by the pressure of first press mold 200, each of the transfer film and the adhesive layer for sliced veneer on transparent base material 2 are softened by heat conduction from first press mold 200, and the transfer film on which a transfer layer is formed and a portion of the adhesive layer for sliced veneer formed on transparent base material 2 enter into a conduit (not illustrated) on the front surface of sliced veneer 101. At this time, the air inside the conduit on the front surface of sliced veneer 101 is also activated by the heating of first press mold 200 and second press mold 201. Therefore, when the transfer film and the adhesive layer for sliced veneer on transparent base material 2 enters, a portion of the air in the conduit on the front surface of sliced veneer 101 is pushed out. As a result, in protective layer 4 formed on the transfer film on the conduit of sliced veneer 101 or the adhesive layer for sliced veneer formed on transparent base material 2, a portion of each adhesive layer for sliced veneer gradually enters the inside of the conduit on the front surface of sliced veneer 101 and adheres thereto.

(2) As illustrated in FIG. 2B, after sufficient heat and pressure are applied to the transfer film on which protective layer 4 is formed, sliced veneer 101, and transparent base material 2 om which printed layer 3 is formed in Step 1, first press mold 200 is operated in Step 2 and moved onto the transfer film on which protective layer 4 is formed.

(3) As illustrated in FIG. 2C, the final Step 3 is a step of taking out the wooden decorative board in a state where the transfer film on which protective layer 4 is formed, sliced veneer 101, and transparent base material 2 on which the printed layer 3 is formed are integrated from the mold.

In addition, in order to improve the followability of the transfer film on which protective layer 4 is formed and transparent base material 2 on which printed layer 3 is formed to sliced veneer 101, a press mold produced with a material other than metal, such as a fluororesin material such as Teflon (registered trademark) or a heat resistant resin material for first press mold 200 and second press mold 201 may be used during hot press processing. As a result, the flexibility of the press mold is increased as compared with the case of using a metal material, and the followability of the transfer film on which protective layer 4 is formed and transparent base material 2 on which printed layer 3 is formed on sliced veneer 101 at the time of heating/pressurizing is improved. In addition, by impregnating sliced veneer 101 with resin in advance, the wooden fibers inside sliced veneer 101 are loosened by the impregnating resin, so that the flexibility of sliced veneer 101 itself is improved, and the transfer film on which protective layer 4 is formed, transparent base material 2 on which printed layer 3 is formed, and sliced veneer 101 can easily follow each other during hot press processing. As a processing method other than the hot press processing, the transfer film on which protective layer 4 is formed and sliced veneer 101 or sliced veneer 101 and transparent base material 2 on which printed layer 3 is formed may be adhered to each other by a vacuum heat laminator, a vacuum forming method, a pressure forming method, or a heating and pressurizing method by a vacuum pressure forming.

### Method of Manufacturing Molded Article Using Wooden Decorative Board

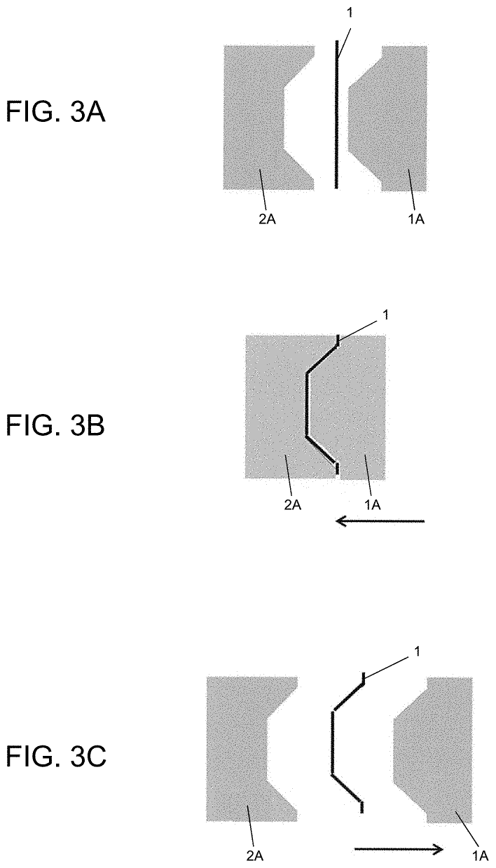

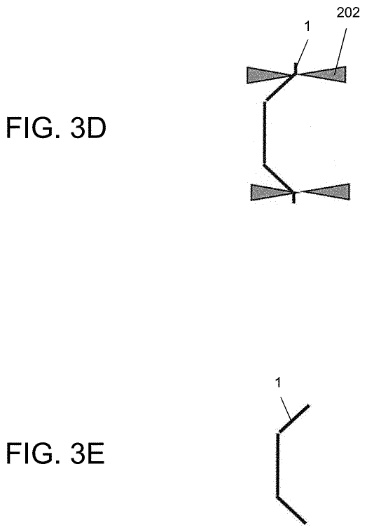

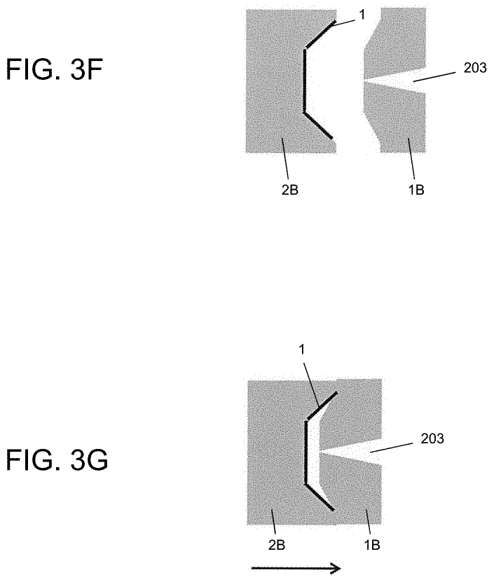

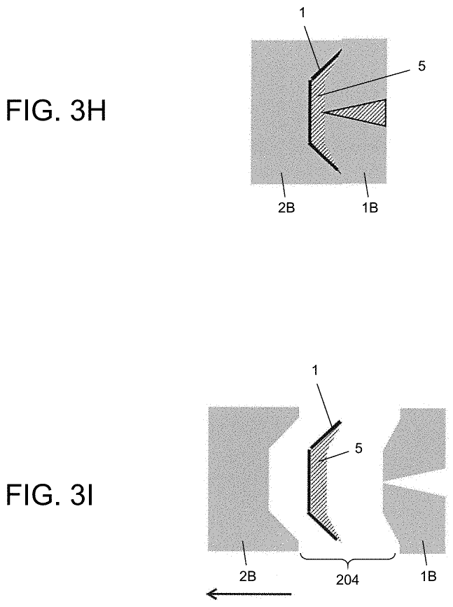

A manufacturing process for transferring wooden decorative board 1 according to Exemplary Embodiment 1 to the front surface of a molded article by insert molding will be described with reference to FIGS. 3A to 3I. In FIGS. 3A to 3I, the same components as those in FIGS. 1 to 2C and FIGS. 8 to 11D are designated by the same reference numerals and the description thereof will be omitted.

(1) As illustrated in FIG. 3A, first, wooden decorative board 1 according to Exemplary Embodiment 1 is disposed between fixed press mold 2A for preform (hereinafter referred to as “fixed mold”) and movable press mold 1A (hereinafter, referred to as “movable mold”). At this time, wooden decorative board 1 is a single sheet.

At this time, wooden decorative board 1 is disposed with protective layer 4 side facing fixed mold 2A.

(2) Next, as illustrated in FIG. 3B, movable mold 1A is operated to perform mold clamping to preform wooden decorative board 1.

(3) Thereafter, as illustrated in FIG. 3C, movable mold 1A is returned to the original state and the preformed wooden decorative board 1 is taken out from the mold. The wooden fibers in sliced veneer 101 in wooden decorative board 1 may be loosened or the flexibility of wooden decorative board 1 may be guided by simultaneously applying moisture and steam to wooden decorative board 1 at the time of preforming. In addition, in a case where water or steam cannot be used due to problems with the sliced veneer sheet or the molding process, by impregnating sliced veneer 101 with a resin in advance, the flexibility of sliced veneer 101 may be improved without using water.

(4) Next, as illustrated in FIG. 3D, in wooden decorative board 1, unnecessary portions of the end surface of wooden decorative board 1 are trimmed by dedicated cutter 202.

(5) As illustrated in FIG. 3E, the trimming is completed and wooden decorative board 1 for insert molding is completed.

(6) Next, as illustrated in FIG. 3F, the preformed wooden decorative board 1 is placed in movable mold 2B and fixed mold 1B for insert molding. At this time, the direction where protective layer 4 of wooden decorative board 1 is formed is disposed toward movable mold 2B side where the suction hole is formed at a portion (not illustrated). At this time, the preformed wooden decorative board 1 is sucked by a suction hole (not illustrated).

(7) As illustrated in FIG. 3G, movable mold 2B is operated to perform mold clamping.

(8) As illustrated in FIG. 3H, injection molding resin 5 is poured into the mold from gate 203 which is open in the fixed mold, and adhered to the adhesive layer for injection molding provided on transparent base material 2 provided in advance on the surface opposite to protective layer 4 of wooden decorative board 1.

(9) As illustrated in FIG. 3I, the mold is opened, and insert-molded article 204 integrally molded with wooden decorative board 1 according to Exemplary Embodiment 1 is taken out from the inside of the mold by a protruding pin (not illustrated).

By repeating the above steps, it is possible to mass-produce insert-molded article 204 integrally molded with wooden decorative board 1.

In a case where the insert-molded article is produced using wooden decorative board 1 according to Exemplary Embodiment 1, the illumination is basically illuminated from the side of printed layer 3 formed on transparent base material 2 of sliced veneer 101, and the insert-molded article is used for the purpose of lifting printed layer 3 on the front surface of sliced veneer 101. Therefore, a resin material having light-transmitting property is used for injection molding resin 5. For example, although there are transparent resin materials such as ABS, PMMA, and PC, it is not particularly limited thereto as long as the same effect can be obtained, and other resin materials may be used.

In addition, also in the insert molding step, similar to the preform step, moisture may be applied to the wooden decorative board to increase flexibility and the followability to the insert molding mold may be improved. Alternatively, sliced veneer 101 impregnated with resin in advance may be used to improve the flexibility of wooden decorative board 1.

In addition, wooden decorative board 1 may be decorated by preform processing other than insert molding, trimming processing if necessary, and pasting on the front surface of the molded article by post-processing by hand pasting or vacuum pressure forming.

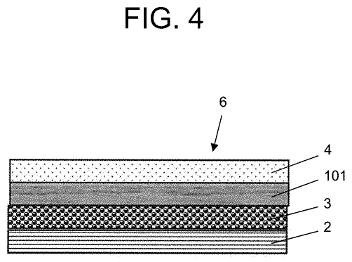

FIG. 4 is a cross-sectional view illustrating the layer structure of wooden decorative board 6 for comparison and verification according to Exemplary Embodiment 1. In FIG. 4, the same components as those in FIGS. 1 to 3I and FIGS. 8 to 11D are designated by the same reference numerals and the description thereof will be omitted. FIGS. 2A to 2C are created to compare the effects of Exemplary Embodiment 1. In the cross-sectional view of the layer structure of the experimental wooden decorative board in FIG. 4, the layer structure in FIG. 4 is also basically formed of the same material as that in FIG. 1, and the surface of transparent base material 2 on which printed layer 3 is formed is the opposite surface. More specifically, in printed layer 3 of wooden decorative board 6 for comparison and verification illustrated in FIG. 4, printed layer 3 is formed between sliced veneer 101 and transparent base material 2. In addition, an adhesive layer (not illustrated) is formed on transparent base material 2 on the surface opposite to sliced veneer 101, and can be adhered to the injection molding resin during insert molding. The manufacturing method was the same as the method of manufacturing the wooden decorative board described with reference to FIGS. 2A to 2C.

In addition, a higher temperature polycarbonate resin or the like may be used as the insert molding resin. Furthermore, by making the printed layer sandwiched by the transparent base material in order to increase the heat resistance of the printed layer, it is possible to prevent the printed layer from being directly exposed to the heat of the molten resin in the injection molding during insert molding. In addition, it is also possible to improve the heat resistance of the printed layer.

### Insert-Molded Article

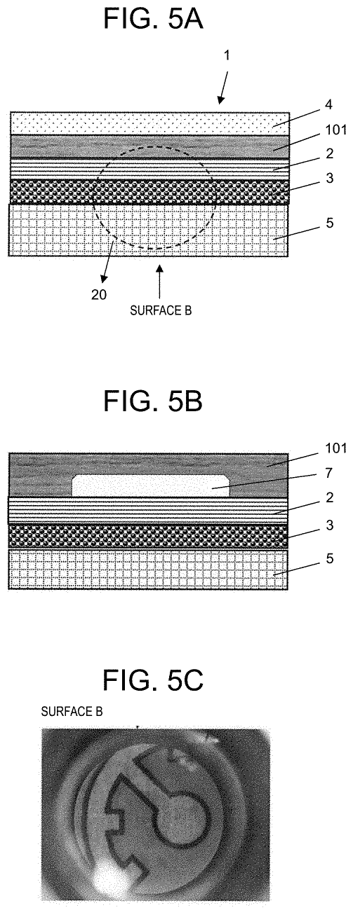

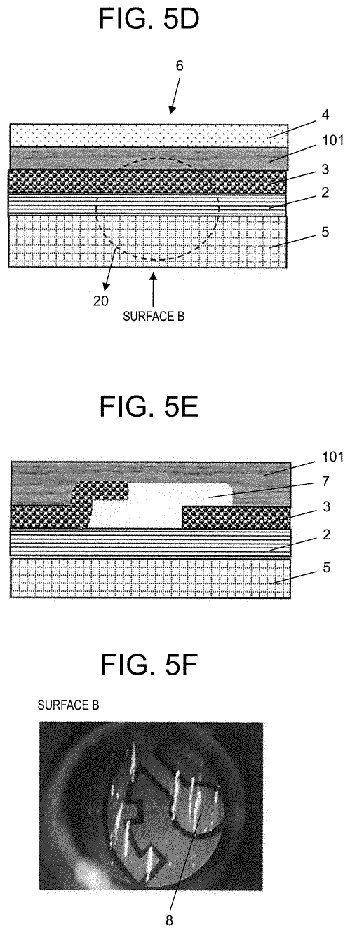

Next, FIG. 5A is a cross-sectional view illustrating a layer structure of an insert-molded article having a wooden decorative board insert-molded using the wooden decorative board according to Exemplary Embodiment 1. In addition, FIG. 5B is a partially enlarged view of dotted line portion 20 of the insert-molded article in FIG. 5A. FIG. 5C is a plan view of printed layer 3 formed on transparent base material 2 from surface B (rear surface) of the insert-molded article in FIG. 5A, which is magnified and observed with a microscope.

In addition, FIG. 5D is a cross-sectional view illustrating a layer structure of an insert-molded article having a wooden decorative board insert-molded by using an experimental wooden decorative board. FIG. 5E is a partially enlarged view of dotted line portion 20 of the insert-molded article in FIG. 5D. FIG. 5F is a plan view of printed layer 3 formed on transparent base material 2 from surface B (rear surface) of the insert-molded article in FIG. 5D, which is magnified and observed with the microscope.

In FIGS. 5A to 5F, the same components as those in FIGS. 1 to 4 and FIGS. 8 to 11D are designated by the same reference numerals and the description thereof will be omitted.

As illustrated in FIGS. 5A to 5F, a case where the insert-molded article using wooden decorative board 1 according to Exemplary Embodiment 1 and the insert-molded article using wooden decorative board 6 for comparison and verification are compared will be described. In wooden decorative board 1 according to Exemplary Embodiment 1 illustrated in FIGS. 5A to 5C, printed layer 3 is formed on transparent base material 2 on the surface opposite to sliced veneer 101 after insert molding. Therefore, printed layer 3 on transparent base material 2 is not press-fitted into multiple conduits 7 existing on the front surface of sliced veneer 101 due to the influence of the injection molding heat and pressure during insert molding. Therefore, as illustrated in FIG. 5C, when viewed with a microscope from the side of injection molding resin 5 formed using highly transparent ABS or PC resin, it can be confirmed that the symbol mark formed on printed layer 3 is insert-molded on transparent base material 2 in a clean state.

On the other hand, as illustrated in FIG. 5D, wooden decorative board 6 prepared for comparison and verification illustrated in FIGS. 5D to 5F has a structure in which printed layer 3 is formed on the surface of transparent base material 2 opposite to wooden decorative board 1 illustrated in FIG. 5A. As a result of insert molding using wooden decorative board 6 for comparison and verification, as illustrated in FIG. 5E of the partially enlarged view, printed layer 3 formed on transparent base material 2 is press-fitted into multiple conduits 7 existing on the front surface of sliced veneer 101 by the heat and pressure of the injection resin applied during insert molding. As a result, when viewed with a microscope from the side of injection molding resin 5 formed using ABS or PC resin having high transparency of the insert-molded article molded using wooden decorative board 6 for comparison and verification illustrated in FIG. 5D, printed layer 3 is partially press-fitted into conduit 7 on the front surface of sliced veneer 101. As a result, it can be confirmed that a portion of printed layer 3 is broken and crack 8 is formed, and crack 8 appears in the symbol mark. This result indicates that the positional relationship of printed layer 3 is important when producing the wooden decorative board for insert molding. Heat and pressure of the injection molding resin are applied to printed layer 3 during insert molding, and printed layer 3 is applied with a force to be pressed against sliced veneer 101. As a result, since transparent base material 2 is also deformed along the front surface of sliced veneer 101, in a case where printed layer 3 is formed on sliced veneer 101 side, printed layer 3 is pressed against conduit 7 on the front surface of sliced veneer 101, and printed layer 3 does not follow the irregular shape of conduit 7, and is easily broken.

On the other hand, in the case of wooden decorative board 1 according to Exemplary Embodiment 1, transparent base material 2 is disposed between printed layer 3 and sliced veneer 101. Therefore, even when printed layer 3 is pressed along the irregularities of the conduit existing on the front surface of sliced veneer 101 due to the influence of heat and pressure of the injection molding resin applied during insert molding, transparent base material 2 does not fit into the irregularities of conduit 7. In addition, since transparent base material 2 has a high strength, transparent base material 2 does not break. As a result, printed layer 3 formed on transparent base material 2 does not break, and the insert-molded article can be formed in a clean state without cracks 8 after insert molding.

### Exemplary Embodiment 2

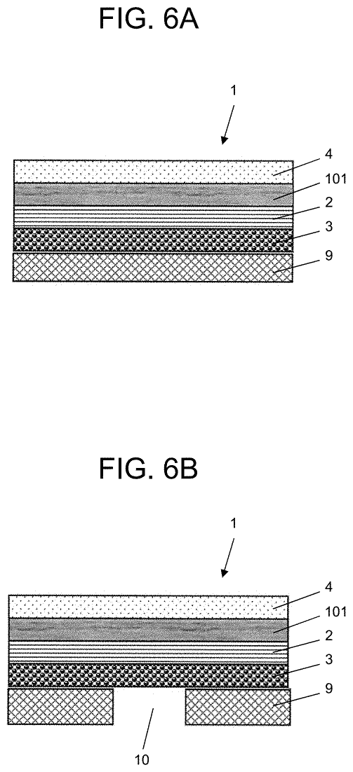

A method for further improving the heat resistance of printed layer 3 during insert molding of wooden decorative board 1 according to Exemplary Embodiment 2 will be described. FIGS. 6A and 6B are cross-sectional views illustrating the layer structure of wooden decorative board 1 according to Exemplary Embodiment 2. In FIGS. 6A and 6B, the same components as those in FIGS. 1 to 5F and 8 to 11D are designated by the same reference numerals and the description thereof will be omitted.

FIGS. 6A and 6B are cross-sectional views illustrating a layer structure for protecting printed layer 3 formed on transparent base material 2 from heat and pressure of the injection molding resin applied during insert molding. In Exemplary Embodiment 2, nonwoven fabric layer 9 is used on the surface of printed layer 3 opposite to sliced veneer 101, and an adhesive layer having an adhesive function with the heat insulating layer and the injection molding resin layer is disposed.

### Nonwoven Fabric Layer

As nonwoven fabric layer 9, a material having a light-transmitting property is used. By using nonwoven fabric layer 9, heat and pressure of the injection molding resin are prevented from being directly applied to printed layer 3 during insert molding, and nonwoven fabric layer 9 provides a heat insulating effect to alleviate heat damage to printed layer 3. In addition, when the injection molding resin flows into nonwoven fabric layer 9 surface during insert molding, nonwoven fabric layer 9 contains innumerable voids inside nonwoven fabric layer 9, and the melted injection molding resin enters into the voids and solidifies, so that the interface between nonwoven fabric layer 9 and the injection molding resin is bonded. As a result, when using a PC resin or the like having a high molding temperature, it possible to effectively prevent the generation of an ink flow caused by melting a portion of printed layer 3 due to the heat of the injection molding resin of printed layer 3. In addition, in a case where the illumination is desired to be illuminated from transparent base material 2 side due to the influence of the light transmittance of nonwoven fabric layer 9, there may be a problem that the light transmittance is lowered and the transmittance of the symbol mark formed on printed layer 3 to the front surface of sliced veneer 101 is lowered. In this case, as illustrated in FIG. 6B, a portion of nonwoven fabric layer 9 is trimmed and cut out only at the position of the symbol mark formed on printed layer 3 in advance. Cutout portion 10 is formed on nonwoven fabric layer 9 and disposed so that cutout portion 10 of nonwoven fabric layer 9 comes to the symbol mark portion formed on printed layer 3 to produce wooden decorative board 1. That is, a portion of nonwoven fabric layer 9 may have a pattern of a specific shape that does not cover transparent base material 2, for example, cutout portion 10. As a result, when the illumination is illuminated from transparent base material 2 side of wooden decorative board 1, it is also possible to display an optical design such as the symbol mark formed on printed layer 3 with high brightness without being affected by the light transmittance of nonwoven fabric layer 9.

The material used for nonwoven fabric layer 9 may be PET, polyethylene (PE), or the like.

From the viewpoint of heat resistance and material cost during insert molding, PET has high cost performance. In addition, there are various methods of manufacturing nonwoven fabric layer 9. For example, there are various manufacturing methods such as a chemical bonding method, a hot embossing method, an air through method, an air through+pressing method, and a needle punching method. In particular, since the needle punching method can form a high-density nonwoven fabric with a thick film, a nonwoven fabric of the needle punching method is used in Exemplary Embodiment 2. In addition, regarding the basis weight of the nonwoven fabric layer, from the viewpoint of light-transmitting property and heat resistance during insert molding, the basis weight of the nonwoven fabric layer used was from 70 to 140 g/m², and 110 g/m² was determined to be optimal for the application this time. However, the basis weight is not limited to the above range depending on the application, and is not limited to this range as long as the desired effect is obtained. Nonwoven fabric layer 9 having a basis weight of 110 g/m² formed by the needle punching method used this time had an average thickness of approximately 1.6 mm at the beginning. In addition, when wooden decorative board 1 is integrated with sliced veneer 101 by the hot press processing described with reference to FIGS. 2A to 2C, the thickness is compressed by the press processing and is thin to the extent of an average thickness of nonwoven fabric layer 9 of approximately 0.2 to 0.4 mm. Therefore, the thickness of nonwoven fabric layer 9 does not matter in the preform pressing or the insert molding step of wooden decorative board 1.

In addition, an adhesive layer (not illustrated) is formed between nonwoven fabric layer 9 and printed layer 3, and the type of the adhesive layer can be bonded using a thermoplastic hot melt sheet, a two-liquids curing type adhesive material, a thermosetting type adhesive material, or the like.

### Modification Example 1

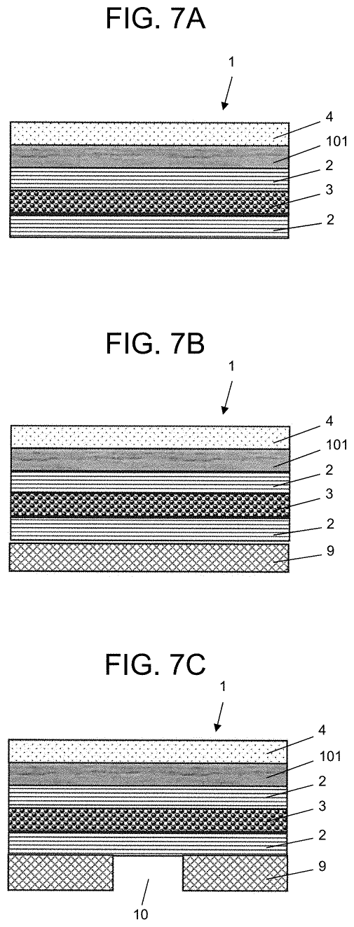

FIGS. 7A to 7C are cross-sectional views illustrating the layer structure of wooden decorative board 1 according to Modification Example 1 of Exemplary Embodiment 2. In FIGS. 7A to 7C, the same components as those in FIGS. 1 to 5F and 8 to 11D are designated by the same reference numerals and the description thereof will be omitted.

In addition, a method for further improving the heat resistance during insert molding as compared with the configuration described in FIGS. 6A and 6B will be described with reference to FIGS. 7A to 7C. Wooden decorative board 1 illustrated in FIG. 7A has a configuration in which printed layer 3 is sandwiched between two pieces of transparent base materials 2 disposed on the rear surface of sliced veneer 101. As a result, printed layer 3 is protected by transparent base material 2 from heat and pressure of the injection molding resin during insert molding, so that the heat resistance of printed layer 3 when molding with high temperature PC resin or the like can be further improved. In addition, in FIG. 7A, although the configuration is described in which printed layer 3 is sandwiched between two pieces of transparent base materials 2, transparent base material 2 may be laminated further on the outer side of transparent base material 2 on the outermost layer of wooden decorative board 1, if necessary. When the transparent base materials are adhered to each other, a thermoplastic hot melt sheet, a two-liquids curing type adhesive material, a thermosetting adhesive material, or the like can be used to bond the transparent base materials as before.

Furthermore, in Modification Example 1, similar to FIGS. 6A and 6B, as illustrated in FIG. 7B, the heat resistance during insert molding may be further improved by disposing nonwoven fabric layer 9 on the outer side of transparent base material 2 disposed on the outermost layer of wooden decorative board 1. In addition, as illustrated in FIG. 7C, cutout portion 10 may be provided on nonwoven fabric layer 9.

The present disclosure includes appropriate combination of any exemplary embodiments and/or examples of the various exemplary embodiments and/or examples described above, and the effects possessed by each of the exemplary embodiments and/or examples can be achieved.

According to the wooden decorative board and the molded article having the wooden decorative board and the method of manufacturing the molded article according to the present disclosure, by turning on the illumination from the surface of the rear surface of the sliced veneer on which the transparent base material is formed, by the original wood texture of the sliced veneer manufactured by slicing natural wood or artificial wood and the printed layer formed on the transparent base material disposed on the rear surface of the sliced veneer, it is possible to display symbols such as symbol marks, geometric patterns, and graphics formed on the printed layer formed on the transparent base material on the rear surface of the sliced veneer in high quality by illumination without impairing the texture of the sliced veneer on the front surface. In addition, according to the present disclosure, it is possible to manufacture a wooden decorative board that is capable of expressing a design having a high-quality optical design in combination with the illumination at low cost and with stable quality. This technology can be widely used as a decoration technology using a wooden decorative board that can display an optical design such as a symbol mark by the illumination from the rear surface as well as a wood design using real wood for resin parts such as external housings for home electric appliances and mobile devices and interior parts for automobiles.

What is claimed is:

1. A wooden decorative board comprising:
a sliced veneer that is formed of a natural wood or an artificial wood having a plurality of irregularities formed by wooden conduits on a front surface; and
a transparent base material disposed on at least one surface of the sliced veneer on a one side, and having a printed layer disposed on a surface opposite to the sliced veneer.

2. The wooden decorative board of claim 1,
wherein the transparent base material is formed of a non-stretched transparent base material, or a cast or extrusion-molded transparent base material.

3. The wooden decorative board of claim 1,
wherein the printed layer is formed of a layer having a light-transmitting property and a layer having no light-transmitting property.

4. The wooden decorative board of claim 1,
wherein the transparent base material has at least two layers or more, and the printed layer is disposed between the two layers of the transparent base material.

5. The wooden decorative board of claim 1,
wherein in the transparent base material disposed on the one surface of the wooden decorative board on the one side, a nonwoven fabric layer is disposed on an outermost layer of the surface opposite to the sliced veneer.

6. The wooden decorative board of claim 1,
wherein in the transparent base material disposed on the one surface of the wooden decorative board on the one side, a nonwoven fabric layer is disposed on an outermost layer of the surface opposite to the sliced veneer, a portion of the nonwoven fabric layer has a pattern of a specific shape not covering the transparent base material, and an adhesive layer is provided on a surface of the transparent base material not covered with the nonwoven fabric layer.

7. The wooden decorative board of claim 1,
wherein a protective layer is provided on a surface of the wooden decorative board opposite to a surface on which the transparent base material is disposed.

8. The wooden decorative board of claim 1,
wherein the sliced veneer is impregnated with a resin in an inside of the sliced veneer.

9. A method of manufacturing a wooden decorative board comprising:
a step of preparing a sliced veneer impregnated with a resin and a transparent base material on which a printed layer is formed; and
a step of laminating the sliced veneer and the transparent base material, adhering the sliced veneer and the transparent base material by any one of methods of hot pressing, vacuum heat laminating, vacuum forming, pressure forming, and vacuum pressure forming, and integrating the sliced veneer and the transparent base material to obtain a wooden decorative board.

10. A method of manufacturing a molded article having a sliced veneer provided on a front surface of the molded article, the method comprising:
a step of preforming a wooden decorative board by hot pressing processing into a shape close to a final product using the wooden decorative board of claim 1; and
an insert molding step of injection molding a molded resin layer on a surface on a transparent base material side of the preformed wooden decorative board.

11. A molded article comprising:
the wooden decorative board of claim 1 on a front surface of the molded article.
